(19) United States
(12) Patent Application Publication
(10) Pub. No.: US 2013/0151307 A1
(43) Pub. Date: Jun. 13, 2013

(54) DERIVING MARKET INTELLIGENCE FROM SOCIAL CONTENT

(71) Applicants: Madhu K. Chetuparambil, Raleigh, NC (US); Kalapriya Kannan, Bangalore (IN); George T. Jacob Sushil, Bangalore (IN)

(72) Inventors: Madhu K. Chetuparambil, Raleigh, NC (US); Kalapriya Kannan, Bangalore (IN); George T. Jacob Sushil, Bangalore (IN)

(73) Assignee: INTERNATIONAL BUSINESS MACHINES CORPORATION, Armonk, NY (US)

(21) Appl. No.: 13/316,950

(22) Filed: Dec. 12, 2011

(51) Int. Cl. G06Q 30/02; G06F 17/30

(52) U.S. Cl. 705/7.29

(57) ABSTRACT

Methods and arrangements for deriving market intelligence. Guidelines for deriving mercantile intelligence are input, and social content data is mined. A map is generated which reconciles the social content data with the guidelines, and elements related to mercantile intelligence are extracted from the map. A mercantile intelligence report is output.

### BACKGROUND

Generally, manufacturers invest considerable monetary and other resources in obtaining valuable marketing information such as consumer requirements and expectations, satisfaction with a product, market threats, market trends and predictions, and a host of other types of information. In gathering and analyzing such information, conventional approaches employ raw data such as sales quantity and other information as may be derived, e.g., from consumer feedback forms. Such approaches often prove to be complex and time-consuming, relying on the collection and analysis of data that involves human expertise.

### BRIEF SUMMARY

In summary, one aspect of the invention provides a method comprising: inputting guidelines for deriving mercantile intelligence; mining social content data; generating a map which reconciles the social content data with the guidelines; extracting from the map elements related to mercantile intelligence; and outputting a mercantile intelligence report.

Another aspect of the invention provides an apparatus comprising: at least one processor; and a computer readable storage medium having computer readable program code embodied therewith and executable by the at least one processor, the computer readable program code comprising: computer readable program code configured to input guidelines for deriving mercantile intelligence; computer readable program code configured to mining social content data; computer readable program code configured to generate a map which reconciles the social content data with the guidelines; computer readable program code configured to extract from the map elements related to mercantile intelligence; and computer readable program code configured to output a mercantile intelligence report.

An additional aspect of the invention provides a computer program product comprising: a computer readable storage medium having computer readable program code embodied therewith, the computer readable program code comprising: computer readable program code configured to input guidelines for deriving mercantile intelligence; computer readable program code configured to mining social content data; computer readable program code configured to generate a map which reconciles the social content data with the guidelines; computer readable program code configured to extract from the map elements related to mercantile intelligence; and computer readable program code configured to output a mercantile intelligence report.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates a system architecture.

FIG. 2 schematically illustrates a process for assigning product utility value.

FIG. 3 sets forth a process more generally for deriving market intelligence.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

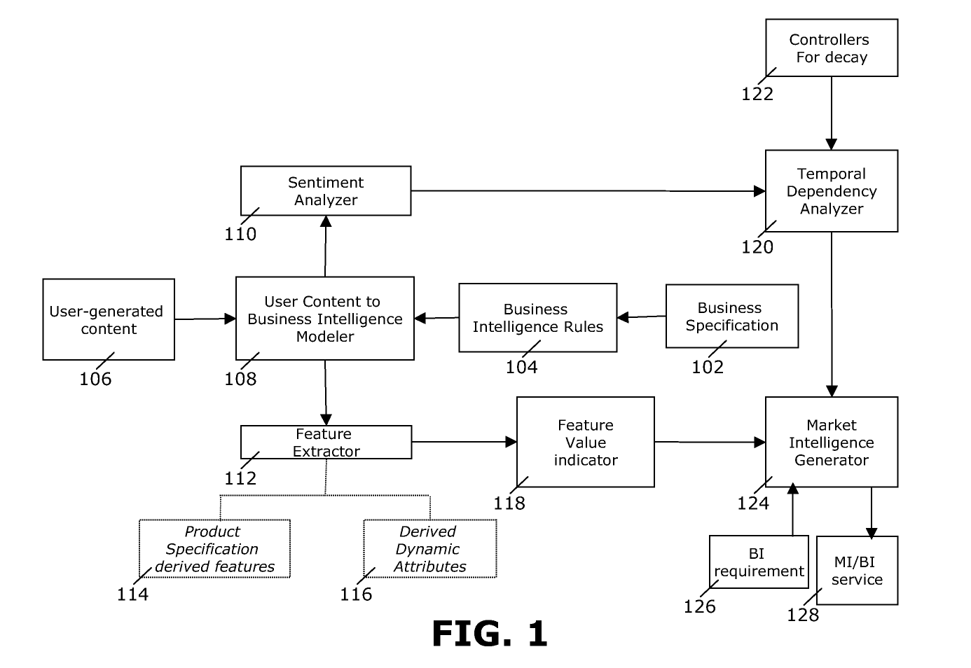

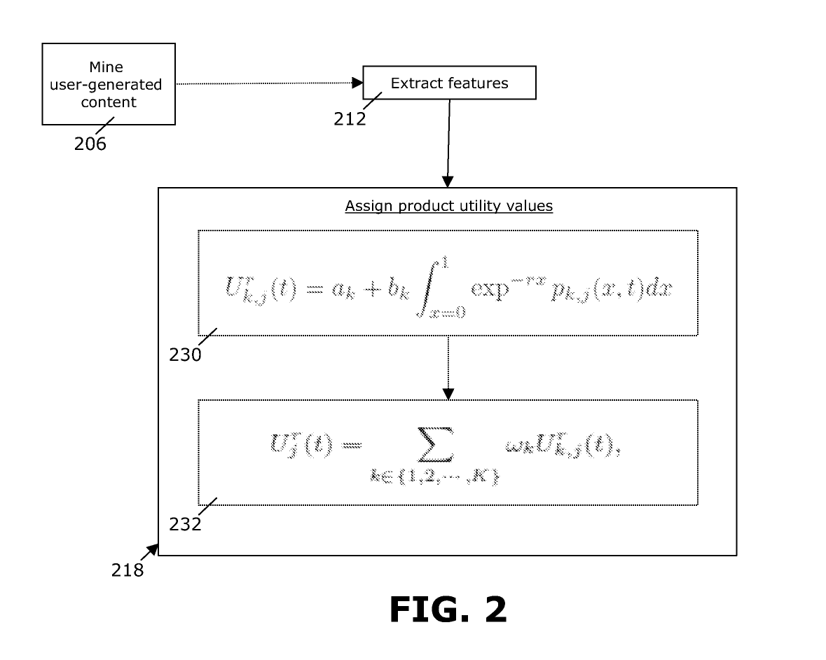

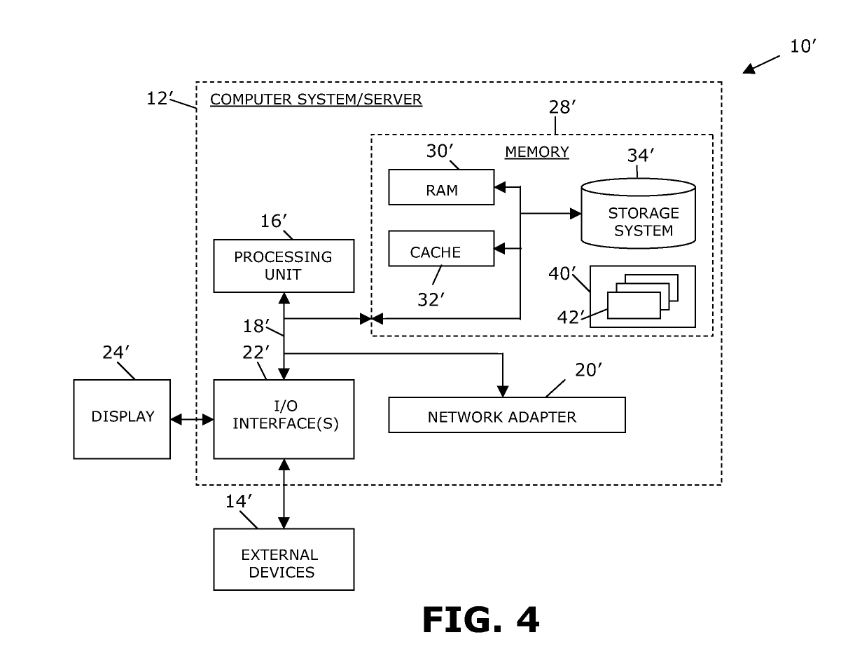

The disclosure now turns to FIGS. 1 and 2. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1 and 2 can be performed or utilized by way of a processing unit or units and system memory such as those indicated, respectively, at 16′ and 28′ in FIG. 4, whether on a server computer, a client computer, a node computer in a distributed network, or any combination thereof.

To facilitate easier reference, in advancing from FIG. 1 to and through FIG. 2, a reference numeral is advanced by a multiple of 100 in indicating a substantially similar or analogous component or element with respect to at least one component or element found in FIG. 1.

In accordance with at least one embodiment of the invention, there are broadly contemplated herein methods and arrangements for obtaining market intelligence through social media. As such, the growing popularity of social media and the enormous amount of data being collected through such forums represents a viable and promising alternative to conventional efforts. Broadly contemplated herein is a comprehensive framework representing a pluggable mechanism that integrates data from various sources, facilitates analysis of the data for different business intelligence (BI) purposes, and provides a mechanism via which both consumers and manufactures can, on an on-demand basis, consume and make use of both the data and the analyses performed thereupon. Particularly contemplated herein are methods and arrangements via which different sources of data are integrated and several types of BI analysis are performed (e.g., market threats, performance trends, consumer expectations, price and revenue predictions etc.,) and is made available to consumers (which can include both manufactures and product/service consumers) on an on-demand basis.

FIG. 1 schematically illustrates a system architecture in accordance with at least one embodiment of the invention. A business intelligence specification 102 is provided in advance for deriving formal rules 104 for expressing business intelligence (BI) 104. Particularly, such rules 104 indicate and convey predetermined requirements and expectations for the quantitative analysis of BI. User-generated content 106 serves as another major input, and it can be understood that deriving BI based on the user content 106 involves analysis of guidance provided by the rules 104 for expectations of what is to be mined from the user content 106. By way of illustrative and non-restrictive examples, such expectations can involve ascertaining product performance, general product facts, consumer expectations, features that predominate in customer discussions of a product, and sentiments associated with any or all of such parameters, or more. A modeler of user content to BI (108) generates a map that relating the BI terms to social content terms. “Terms” here are mentioned in a linguistic sense, in consideration of differing sets of terms being used to indicate performance metrics in a BI context and a social content context, respectively. As such, a map can encompass a simple mapping of terms from BI specifications to content in social data to provide information or guidance on what type of information from social content would need to be looked for in deriving BI.

In accordance with at least one embodiment of the invention, a sentiment analyzer 110 and feature extractor 112, configured respectively for extracting those sentiments and features that directly contribute to BI. Feature extractor 112 can be guided to ascertain different types of features, such as those derived from product specifications (114) or attributes derived dynamically (116). (Dynamically derived attributes 116, for their part, can arise from a great variety of scenarios. For instance, information on the service of a product might not be provided by the manufacturer and thus could be derived dynamically as consumers provide information through social content. Service quality, as such, can be looked upon as one of those attributes that consumers often request but are not readily available from the manufacturer or retailer, and thus may need to be dynamically derived as social content comes through, if derived at all. Other examples of dynamically derived attributes can include the quality of reception or battery life of a mobile phone, as ascertained from users' experience.)

Thence, in accordance with at least one embodiment of the invention, the prevalence and importance of features are measured via statistical analysis with a feature value indicator (118). Further, extracted sentiments are mapped to an assessment value during the duration of the active period of the life cycle of the product, via employing a temporal dependency analyzer 120 (which also takes into account controllers for product-related decay, 122). While, in the context of embodiments of the invention, there are a wide variety of possible algorithms or arrangements for suitably mapping extracted sentiments to an assessment value (or product utility value) in a step such as this, an advantageous working example is set forth in Appendix A, attached hereto.

In accordance with at least one embodiment of the invention, a market intelligence (MI) generator 124 then accommodates a given business intelligence requirement 126 (e.g., as accommodated on an as-needed or ad-hoc basis), such as price prediction and performance trends, and performs an analysis which then can be made available to an end-consumer as a MI or BI service 128.

In accordance with at least one embodiment of the invention, and by way of an illustrative and non-restrictive example, FIG. 2 illustrates a process for assigning product utility value, inasmuch as this can represent a feature value as discussed heretofore. User generated content, such as user reviews (as might appear in comments on a social network, for instance), are mined (206) and the relative importance of product features are ascertained. As such, a rule is applied to arrange the features in the order of the importance for each product, by use of a weight W calculated as a function of opinions (e.g., the number of positive opinions obtained versus the number of negative opinions obtained) for a product feature divided by the total number of opinions on the product feature. First, features are extracted (212) by querying a catalog system and as part of this, for each feature, opinions are extracted. W is derived based on a principle that the importance of a feature is reflected by the amount of “noise” that it creates in the user generated content.

In accordance with at least one embodiment of the invention, and by way of the present example, assigning product utility values (218) involves consideration of factors including: opinions expressed over time an exponential component for modeling the natural decay of a value of the product during its lifetime (wherein controllers for decay can be employed, as indicated at 122 in FIG. 1); and most important features of the product, as relatively valued by consumers. The expected attribute utility value of attribute K of the product j at time t is expressed in equation 230. Product utility value is then calculated as in equation 232, as a weighted sum of expected attribute utility values (EAUV's). By way of illustrating the usefulness of these calculations, a prior product feature utility value can be considered to be analogous to brand value, deriving utility value over time.

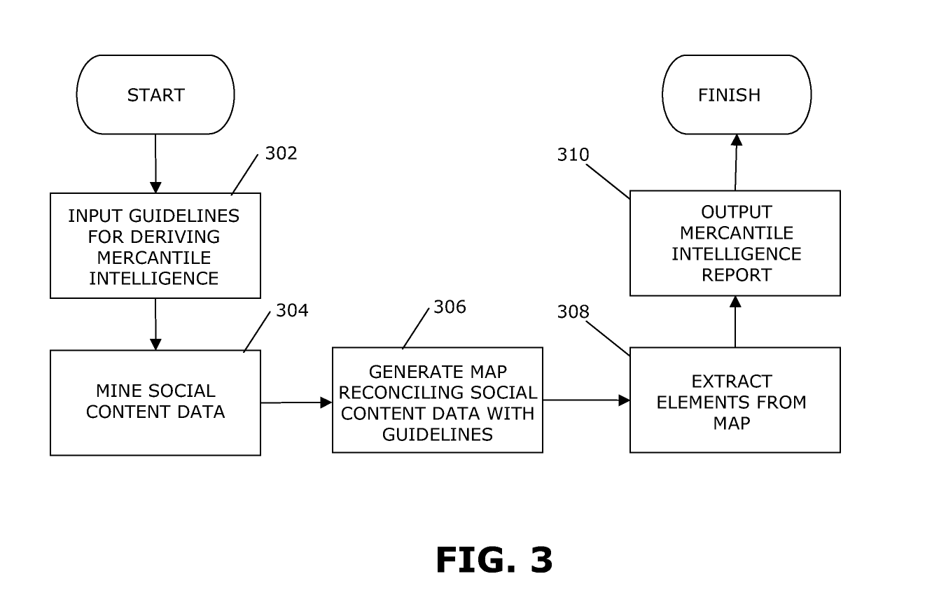

FIG. 3 sets forth a process more generally for deriving market intelligence, in accordance with at least one embodiment of the invention. It should be appreciated that a process such as that broadly illustrated in FIG. 3 can be carried out on essentially any suitable computer system or set of computer systems, which may, by way of an illustrative and on-restrictive example, include a system such as that indicated at 12′ in FIG. 4. In accordance with an example embodiment, most if not all of the process steps discussed with respect to FIG. 3 can be performed by way a processing unit or units and system memory such as those indicated, respectively, at 16′ and 28′ in FIG. 4.

As shown in FIG. 3, guidelines for deriving mercantile intelligence are input (302), and social content data is mined (304). A map is generated which reconciles the social content data with the guidelines (306), and elements related to mercantile intelligence are extracted from the map (308). A mercantile intelligence report is output (310).

Referring now to FIG. 4, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that is accessible by computer system/server 12′, and it includes both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ by way of example, and not limitation, as well as an operating system, at least one application program, other program modules, and program data. Each of the operating system, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enable a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples, include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

1.-12. (canceled)

13. An apparatus comprising:
at least one processor; and
a computer readable storage medium having computer readable program code embodied therewith and executable by the at least one processor, the computer readable program code comprising:
computer readable program code configured to input guidelines for deriving mercantile intelligence with relation to a product;
computer readable program code configured to mine social content data with relation to the product, the social content data comprising user-generated content with relation to the product;
computer readable program code configured to generate a map which reconciles the social content data with the guidelines;
computer readable program code configured to extract from the map elements related to mercantile intelligence; and
computer readable program code configured to output a mercantile intelligence report with relation to the product.

14. A computer program product comprising:
a computer readable storage medium having computer readable program code embodied therewith, the computer readable program code comprising:
computer readable program code configured to input guidelines for deriving mercantile intelligence with relation to a product;
computer readable program code configured to mine social content data with relation to the product, the social content data comprising user-generated content with relation to the product;
computer readable program code configured to generate a map which reconciles the social content data with the guidelines;
computer readable program code configured to extract from the map elements related to mercantile intelligence; and
computer readable program code configured to output a mercantile intelligence report with relation to the product.

15. The computer program product according to claim 14, wherein the mercantile intelligence comprises at least one taken from the group consisting of: business intelligence, market intelligence.

16. The computer program product according to claim 14, wherein said computer readable program code is configured to:
input a mercantile intelligence specification; and
derive therefrom formal rules for expressing mercantile intelligence.

17. The computer program product according to claim 14, wherein the extracted elements include product-related features.

18. The computer program product according to claim 17, wherein the product-related features include at least one taken from the group consisting of: at least one product specification, at least one dynamically derived product attribute.

19. The computer program product according to claim 17, said computer readable program code is further configured to measure features quantitatively via statistical analysis.

20. The computer program product according to claim 17, wherein the product-related features include product utility value.

21. The computer program product according to claim 20, said computer readable program code is further configured to ascertain product utility value as a weighted sum of expected attribute utility values.

22. The computer program product according to claim 21, wherein said computer readable program code is configured to model product value decay over time and mine social content data with relation to the product over time.

23. The computer program product according to claim 14, wherein the extracted elements include consumer sentiments relating to a product.

24. The computer program product according to claim 23, said computer readable program code is further configured to map consumer sentiments to assessment values.

25. The computer program product according to claim 24, wherein the social content data includes user reviews of a product.
